(19) United States
(12) Patent Application Publication
(10) Pub. No.: US 2016/0094414 A1
(43) Pub. Date: Mar. 31, 2016

(54) SYSTEM, METHOD AND COMPUTER-IMPLEMENTED ALGORITHM FOR CLIENT LIFECYCLE EXCHANGE MANAGEMENT

(71) Applicant: Client Lifecycle Solutions LLC, Highland, NY (US)

(72) Inventors: Diana Merenda, Manhasset, NY (US); Ullaas Menon, Edison, NJ (US)

(73) Assignee: Client Lifecycle Solutions LLC, Highland, NY (US)

(21) Appl. No.: 14/276,953

(22) Filed: May 13, 2014

Related U.S. Application Data
(60) Provisional application No. 61/823,846, filed on May 15, 2013.

(51) Int. Cl. H04L 12/24; H04L 29/06; H04L 29/08

(52) U.S. Cl. CPC H04L 41/5054; H04L 41/5051; H04L 41/5009; H04L 67/16; H04L 67/42

(57) ABSTRACT

The present invention concerns generally with client lifecycle exchange management, and, more particularly, with a method, a computer system, and a computer-implemented algorithm for managing and coordinating events in the asset management industry that relate to the acquisition and retention of clients and their portfolios, as well as the management of those events that relate to changes in on-going client contracts, including terminations of said contracts at the appropriate time, real-time collaborations between various functional areas of the organization.

This application claims the benefit of U.S. Provisional Application No. 61/823,846 filed May 15, 2013.

### FIELD OF THE INVENTION

The present invention concerns generally with client lifecycle exchange management, and, more particularly, with a method, a computer system, and a computer-implemented algorithm for managing and coordinating events that relate to the acquisition and retention of clients and their portfolios, as well as the management of those events that relate to changes in on-going client contracts, including terminations of said contracts at the appropriate time.

### BACKGROUND OF THE INVENTION

As enterprises evolve into more and more distributed organizations, they face the increasingly difficult problems managing client events and creating new products that will serve those clients. Large quantities of information associated with client event management and new product development pose serious challenges to enterprises, particularly with regard to reputational and compliance risks, product suitability, and organizational data accuracy. Such regulatory developments as the Sarbanes-Oxley Act of 2002, the Dodd-Frank Wall Street Reform and Consumer Protection Act of 2010, HIPAA, and others, establish new standards of transparency, record keeping and reporting, and impose additional requirements on client event management. Typical issues faced by many organizations usually stem from lack of coordination among and across different departments of a company while managing clients' events. A great majority of client servicing industries, including asset management firms, struggle with managing the workflow of servicing clients in a risk-controlled manner, as well as with securely maintaining critical documentation associated with clients' events.

One logical approach to addressing these issues lies in creating a real-time computer-based collaborative messaging exchange that would allow an enterprise to manage its clients' events more intelligently by improving efficiency of communications among and across the company's departments. In such messaging exchange, electronic data flows from one computer system to another or within the same computer system via networking devices such as firewalls, routers, wireless access points, switches, storage devices, and appliances. Departments may be construed as being distinct or as groups or sub-groups within larger organized areas in the firm.

In recent years, multiple solutions have been developed directed at creating such exchanges. These solutions generally fall into one of several categories: (a) completely manual—a company that wants to adapt such a solution must have low turnover, highly skilled and experienced stuff, totally transparent communication networks and generally experience growth organically without benefit of acquisition and/or merger; (b) generic computer-based—a company solicits a generic solution from software development firms and then engages in programming based on its specific requirements; and (c) a combination of the two, where the bulk of the client-event management is still conducted manually, but certain, usually routine tasks are automated using limited resources of an in-house IT department. Although popular, the majority of these solutions have been designed without true real-time workforce collaboration in mind and they do not allow users to work together in a truly real-time integrated manner. Other solutions, albeit aimed at enabling client servicing organizations to better serve clients while satisfying regulatory requirements and mitigating enterprise risks, do not address key needs of typically related client-servicing areas, including, but not limited to, creating new products, hiring vendors, engaging in client side-letter agreements, all the while conducting real-time collaborations and integrating approving processes.

An example of such a solution is the invention described in the U.S. Pat. No. 8,271,305 (the '305 patent), which details a system directed at account level participation for underwriting components. Similarly to the present invention, the '305 patent allows storing, viewing and manipulating client information. Unlike the present invention, however, the '305 invention offers no real-time collaboration.

The concept of event managing exchanges has been mentioned in earlier patents and patent publications. For example, the U.S. Pat. No. 7,010,530 (the '530 patent) describes a system for planning, management and execution of events that permits multiple entities to coordinate activities and rapidly disseminate information. Similarly to the present invention, the '530 patent allows client event information to be electronically relayed in real time to various parties. The '530 patent, however, is directed at broadcasting the information from the central repository and not with real-time collaborations and exchanges of information between the parties.

A method and apparatus for implementing a real-time enterprise event management system is disclosed in the U.S. Pat. No. 7,454,459 (the '459 patent). The enterprise event management system couples together various “event aware” computing resources that publish and subscribe to “events” that provide information about the state of said computing resources. Although directed to real-time exchange of information, the '459 patent relates to managing events pertinent to electronic devices and provides no answers to the issues faced by such client-servicing firms as in firms the asset management industry.

A Web-based employee on-boarding management and tracking software system is described in the U.S. Patent Publication 2006/0080116 (the '116 publication). The system is based on a compilation of checklists covering on-boarding of a new employee, and unlike the present invention, the '116 publication offers no mechanisms for real-time collaborations and integrated approvals.

The U.S. Pat. No. 8,041,616 (the '616 patent) is directed at an outsourced service level agreement provisioning management system and a method. Similarly to the present invention, the '616 patent is concerned with facilitating procurement and logistical planning of human-capital deployments. However, and unlike the present invention, the '616 patent relates to the system and method pertinent to outsourcing of service-level-agreement deliverables, and addresses no issues solved by the present invention, such as real time collaboration.

And finally, there is the U.S. Patent Publication 2010/0106635 (the '635 publication) offering a method, a system and a computer-implemented algorithm aimed at developing client relationships. The method includes determining information desired to be included in a client relationship profile, inputting client identification information into an interface and querying a plurality of operation areas with the client identification information. Thus, the '635 publication is concerned with a technique for obtaining detailed client information in response to client's requests, and neither provides a solution for managing client events nor enables real-time collaborations and integrated approvals.

As we demonstrated, on-boarding and servicing clients in a risk-mitigated, controlled and productive way is a serious issue for client servicing enterprises, especially, but not limited to, asset management firms and the like. The current invention provides such firms with ability to adapt new clients, and to service existing clients more efficiently and in a risk-controlled manner. Moreover, the present invention provides functionality for storing and managing documentation associated with the client events in one place for convenient retrieval by authorized employees and for the benefit of regulatory reviews and audits whether internal or external, for as long into the future as mandated by the company's senior management and/or policies and procedures. Thus, the present invention enables client-servicing firms to better serve their clients while at the same time satisfying financial regulatory requirements and mitigating enterprise risks.

### SUMMARY OF THE INVENTION

The present invention is designed to mitigate client-servicing enterprise risks while on-boarding new clients and products, or making changes to existing clients and products, or managing the lifecycle of any project involving more than one department in a firm, including, but not limited to new product development, contract analysis, or side-letter agreements. To date, the current invention is the only pre-programmed workflow-approval computing platform that is fully programmed “out of the box” and has been endorsed by the industry's subject matter experts. The invention programming as currently exists is capable to be modified if a particular company desires fewer fields to be incorporated or more for that matter, or allows modification of a field name that may be listed in one manner out of the box, but desired to be referred to in another manner by a particular company. Such flexibility also permits ease of adaptation as time goes on as the invention takes into consideration that as senior management may change at the company level, so to may there be a need to change or adapt fields. Thus, the invention becomes an adaptable part of the long-term technological solutions for the company.

The present invention manages lifecycle events for prospective, new, existing and former clients. In some embodiments, the present invention is capable of managing potential new products, potential vendor contracts and side-letter agreements within the firm, and is critically able to assist in the tracking and management of client “trigger events”. Trigger events are by definition challenging for companies to manage on behalf of clients because they concern themselves with events that have not yet happened but, in the event they do happen in future state, require a particular action be implemented by virtue of the client contract. A typical example relates to change of ownership control at the company level. By contract, it is fairly typical for a client contract to demand that in the event of a change of ownership control at the company level that the client is notified in writing as to the nature of the event and its impact to the client and the client's account. The present invention incorporates a way to capture such a future deliverable, or “trigger event”, assign it to a particular area in the firm as well as a back-up area, thus enabling some future query perhaps years into the future to identify which clients are to be informed about the afore-mentioned ‘change of control’ example. The ability to manage the company's reaction to trigger events is invaluable to the client-servicing effort and is independent of whether the employee himself or herself is still with the firm. So long as the departmental area of responsibility exists—in the example of ‘change of control’—it would be the finance department as primary and the legal department as backup—the responsibility will have a place through which the deliverable initiated by the trigger event will be implemented. This concept is extremely well received both by compliance as well as client-servicing professionals who are committed to providing excellent client service to clients and especially if it is a demand of the client contract.

In client servicing generally and the asset management industry in particular, it is widely accepted that there are four stages in the lifecycle of a client: (1) a prospective client; (2) a new client; (3) an existing client, and (4) a former client.

When dealing with a prospective client, the situation is generally referred to as an “opportunity”. When a prospective client agrees in principal to hire the firm, the client transitions from being “prospective” to becoming “new” through the on-boarding process. During the on-boarding process, the new client sets forth the terms, guidelines and specifications by way of the original investment management agreement (IMA); thus, becoming “existing” once all the terms and conditions are in agreement between the client and the company. As portfolio management proceeds and continues over time, it is not unusual for the then-existing client to change certain of the initially agreed-upon terms, guidelines and specifications, and the new terms and conditions are subsequently incorporated into either a the new or amended management agreement. Finally, the client may decide to terminate his relationship with the firm. At that point the client becomes “former”, although the firm's obligations towards the former client do not end at that time.

Once stages of the client lifecycle events are identified and captured in an automated computer-based system, various departments or areas of responsibility of the organization must have access to the events that are stored, processed, and transferred between computers that comprise said automated computer-based system. The present invention offers a method, a system and a computer-implemented algorithm that enables the company to conduct real time collaborations between departments in regard to the client's event at hand. In some embodiments, the present invention represents a workflow approval software platform that guarantees that all parties who do have responsibility for the event do actually know what they are supposed to do, when they are supposed to do it, confirm they have the necessary human and/or technical resources for doing it and finally actually assert that they will in fact do it. In addition, the present invention allows client event documentation to be uploaded and permanently linked to the client event at hand.

During the workflow, each department, by utilizing a computer network, Internet or Intranet, is able to learn in real time the actions and feedbacks from other departments and at the same time providing a valuable source of information in case of internal audits, compliance and regulatory reviews. Moreover, sharing of such actions and feedbacks can lead to the other departments' realizing a potential issue, challenge or concern over which they did not previously ponder. In such a way, collaboration adds value to the organization as a whole and to the overall client service effort in ways not previously envisioned.

In some exemplary embodiments, the present invention comprises six functional modules representing a system, a method and a computer-implemented algorithm aligned with or related to one of the four foregoing client event lifecycle stages in some manner. In addition, there are two additional modules, one for new product development to augment the creation of products for business distribution, and the other for vendor contract analysis to augment the firm's overall risk management and monitoring.

Module 1 serves as the “Opportunity Preview” designed to proactively review potential issues with a possible future client's on-boarding before said onboarding actually occurs.

Module 2 serves as the “Client On-Board” layer, which examines all aspects of operational, investment and compliance readiness to deploy the client's funds and meet the firm's fiduciary responsibility requirements.

Module 3 is dedicated to “Side-Letter Agreements”. This module is based on the same principals as a described below “Contractual Changes” module. Both these modules are usually set in place simultaneously with a client that is contracting with the company for a specific Private Placement Memorandum (PPM) or similarly typical contract that neither party wishes to amend.

Module 4 “Contractual Changes” processes changes to the current client's contract subsequent to the initial on-boarding, resulting in an amended contract or additional or different schedules and/or addendums.

Module 5 “Termination” clarifies the timing for the last fee invoice; the period of the last client report; determines when to stop active portfolio management, how the assets are to be transferred out, when to turn off systems related to the portfolio's closure, and determine any impact on market performance of composites according to industry standards set forth by the Global Investment Performance Standards® of the Chartered Financial Analyst Institute.

Module “Trigger Events” captures any delineations specified in a client's Investment Management Agreement or similar Contract outlining potential future deliverables that are to be implemented on an ‘if-this-happens-in-the-future-at-the-company-then-the-company-must-notify-the-client-in-writing’ basis, or similar “if/then” scenario, then enables the assignment of the potential task(s)/deliverables to a primary and backup area of responsibility in the firm. It should be noted that although any of the Client Lifecycle Exchange® modules can be bifurcated from the entire system and provided to the company on a stand-alone basis, the Trigger Events module in particular can be offered in conjunction with the entire system or as a separate module for use by the company.

In some exemplary embodiments, the present invention handles an additional task of “New Product Development”, which is based on the same functionality as a “New Client On-boarding”; however, although there is no “client” to be on-boarded, substantially the same inter-departmental approvals are necessary.

In some other exemplary embodiments, the present invention is capable of undertaking an additional task of “Vendor Contract Analysis”, which is based on the same workflow as the “Opportunity Preview” client stage. Yet in other exemplary embodiments, the present invention comprises the “Customized Workflow” module, which is a workflow approval process that may be customized to meet specific requirements of a given client-servicing firm.

### BRIEF DESCRIPTION OF DRAWINGS

These and other features of this invention will be more readily understood from the following detailed description of the various aspects of the invention taken in conjunction with the accompanying drawings in which:

FIG. 1 Shows a general flow of the Client Lifecycle Exchange Management system;

FIG. 2 Lists typical functional areas involved in a typical Client Lifecycle Exchange Management process;

FIG. 3 Depicts a sample workflow diagram of the Client Lifecycle Exchange Management;

FIG. 4A Depicts initial portion of the sample Opportunity Preview page;

FIG. 4B Shows functional area selection portion of the sample Opportunity Preview page;

FIG. 5 Shows initial portion of a sample New Client On-Boarding page;

FIG. 6 Shows initial portion of a sample Side Letter Agreement page;

FIG. 7 Shows initial portion of a sample Contractual Changes page;

FIG. 8 Shows initial portion of a sample Termination page;

FIG. 9 Depicts Accounts Trigger Events page;

FIG. 10A Depicts Attestation Section of the Approval Billing page;

FIG. 10B Depicts Approval Section of the Approval Billing page;

FIG. 11 Depicts schematics of the Client Lifecycle Exchange Management system;

### DETAILED DESCRIPTION OF THE INVENTION

The following is a detailed description of the invention provided to aid those skilled in the art in practicing in the field of the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

The present invention is directed at a system, a method, and a computer-implemented algorithm for Client Lifecycle Exchange management, and, more particularly, at a computer network-based method, a system, and a computer-implemented algorithm for managing and coordinating various client-related events in settings of a typical client-servicing enterprise.

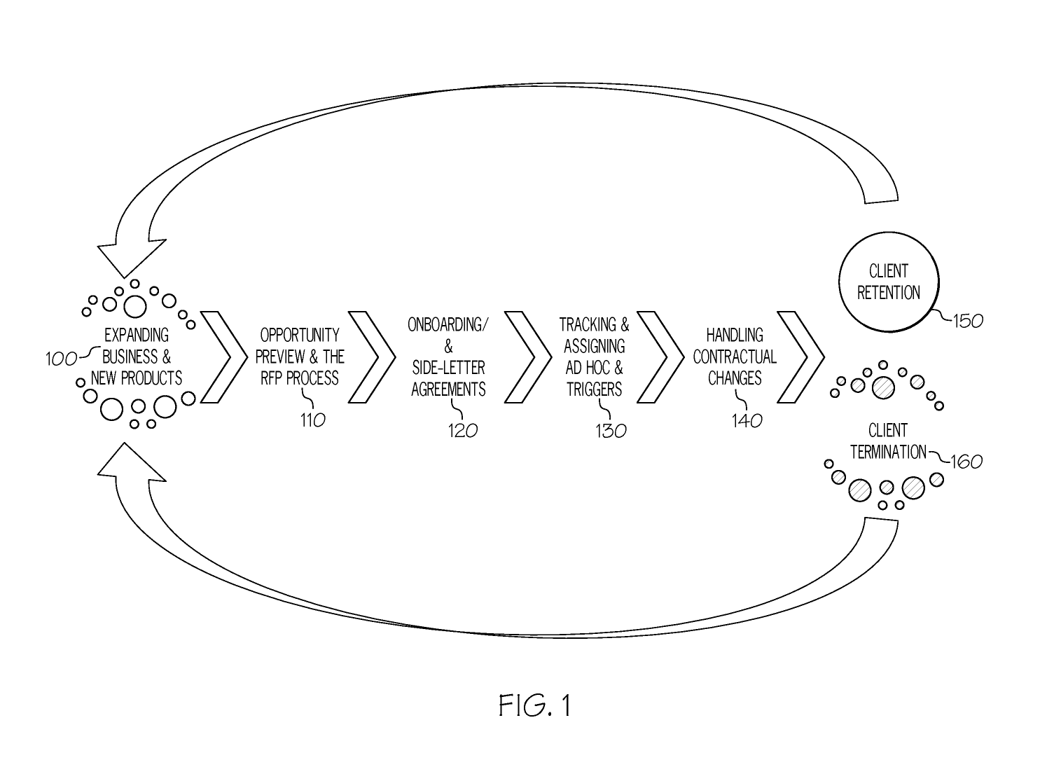

An example of the client lifecycle exchange is shown in FIG. 1. Here we see all the various nodes along the continuum of a client lifecycle including seeking the new client or creating a new product for a client in order to expand the distribution of the business 100; reviewing the opportunity 110 as part of a “preview”, whether to ascertain the suitability of the client for one reason or another, or to entertain whether or not to complete a Request for Proposal (RFP), for example; next is the on-boarding of the client 120 directly through an Investment Management Agreement (IMA) or similar contract, or through the process related to Side-Letter Agreements often used in the business concurrent to when the client and the company are engaged in a Private Placement Memorandum (PPM) or some such similar document for which neither the client nor the company wish to make direct changes for legal reasons; nonetheless, however, both parties “agree to agree” on other matters in a sidebar fashion typically known in the industry as a ‘side-letter agreement’; next 140 would be the contractual changes node of the client's lifecycle whereby after period of time subsequent to the original on-boarding, the client wishes to make alterations to the original contract; thus, resulting in an addendum or appendix or outright change to the original contract; whether as part of the original contract or a subsequently revised contract or even a side-letter agreement, there is always the possibility 130 that the client wishes to be notified—or perhaps wants their consultant or advisor to be notified—in the event there is an occurrence of some predefined event (such “trigger event” shall be identified in advance by the client as part of their IMA), the client wishes to be notified, often in writing, and through CLE® these “trigger events” can be identified, captured, tracked and ultimately queried; and, finally, it is possible that the client may ultimately terminate the relationship with the company 160 in which case it leads to the terminations module in general, and the return of the now-former client to the prospective client category where in the future it is possible to renew the cycle.

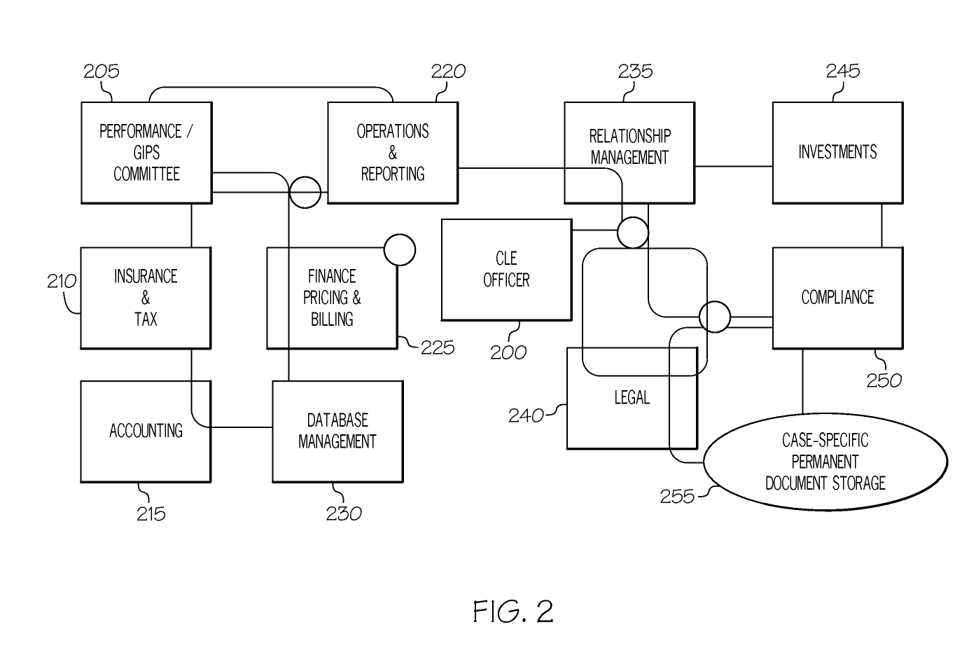

We now are turning to FIG. 2 describing functional areas that are typically involved in the client lifecycle exchange management method. Here, CLE® Officer 200 triggers CLE® input, selects relevant functional areas 205 through 250; thus, starting the dialog exchange, and then awaits approval or rejection by the selected functional areas. Once all requisite approvals or rejections are collected, CLE® Officer issues the final approval or rejection, and attaches the file to the case-specific permanent storage 255.

In some embodiments, as we explained earlier, designated senior managers or superior functional areas may be granted the authority to override previously collected approvals or rejections. Once this authority is exercised, the status of the event is updated accordingly. This construct ensures that the organization embeds risk-taking authority at an appropriately hierarchical and compensated level within the company. In some embodiments, the company may require more than one sign-off at the senior management level to ensure risk is not taken other than after deliberation consistent with the downside the action represents. Actions with greater risk or risk of negative exposure to the client or the company will generally require more deliberation and additional sign-offs relative to less riskier actions. The invention therefore is designed among other constraints to channel the appropriate amount and level of risk to the correct area of the firm such risk, if taken, is done so after consideration by the right parties. In addition to date- and time-stamped (to provide audit trails) approvals, comments, rejections, assessments and so on, the present invention allows the integral functional areas to upload, download, manage or otherwise exchange documentation pertinent to the event at hand. When the documentation is uploaded or otherwise exchanged, it becomes part of the permanent record of the event. All currently known or developed in the future formats are supported, including, but not limited to Excel, PDF, WORD, WordPerfect, JPEG, TIFF, PowerPoint and others.

While the event is being collaborated by the integral functional areas, its electronic record is preserved in the database and may be retrieved or modified by the functional areas or by the case manager. Once all the necessary date- and time-stamped feedbacks, approvals, comments, assessments, and the like are received and the pertinent documents attached, the event's lifecycle becomes complete, the electronic record of the event along with the attached documentation is marked closed and is no longer subject to modifications by the functional areas. Instead, the closed electronic record is stored in the database and may only be modified or purged by the case manager or other authorized personnel according to the document retention policies established by the firm. In some exemplary embodiments, paper records of the complete events are kept in the documentation permanent storage. In some embodiments, the record is archived upon a policy-driven triggering event, including, but not limited to, the expiration of the document retention period as set forth by the documentation policies and procedures.

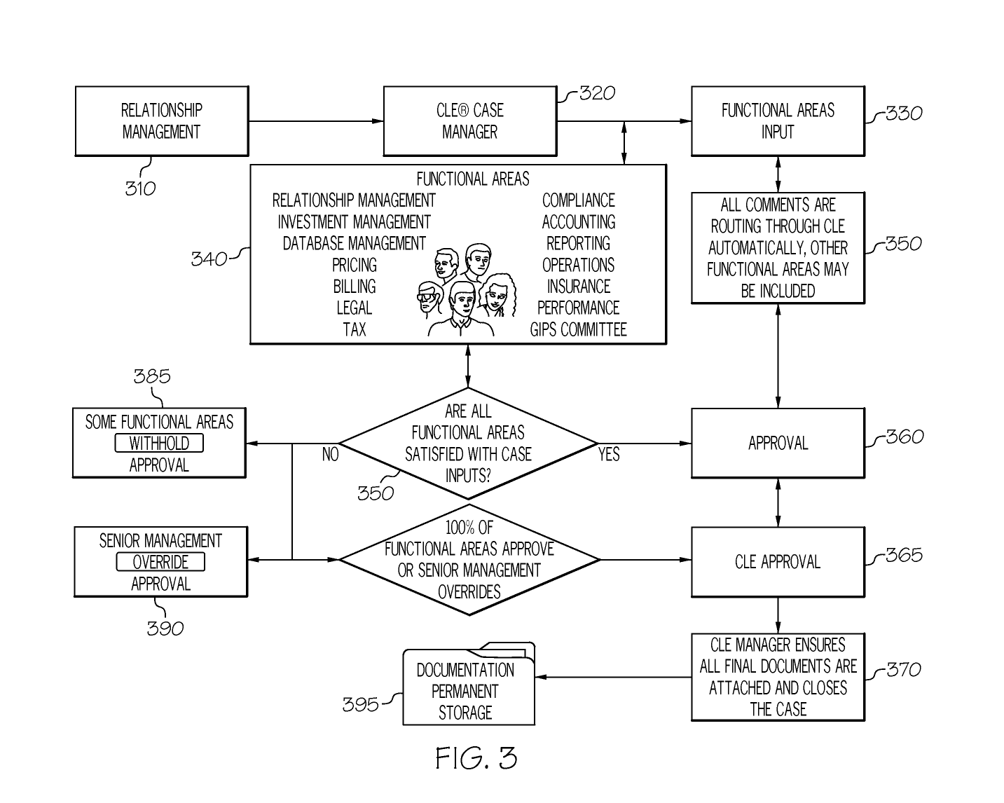

A sample CLE® workflow diagram is shown in FIG. 3. The gist of this invention lies in correlating actions of all integral functional areas in response to the event at hand by allowing real-time collaborations between the integral functional areas, and in providing a mechanism for linking, managing and preserving all documents pertinent to the lifecycle of the event.

The term “Integral functional area” is defined as any organizational entity, sub-entity, department, an individual or a group of individuals that are tasked with participating in the lifecycle of a given event, including, but not limited to, Relationship Management/Sales, Investment Management/Portfolio Management, Database Management/Consultant Database Management, Pricing/Product Management, Billing/Fees, Legal, Compliance, Accounting, Reporting, Operations, Performance, GIPS® Committee, Insurance, Tax, and others. For example, Operations may have responsibility over such functions as account opening, liaison with the custodian for the client, reconciliations, trade settlements and security uploading in the company's Security Master, among other tasks. Compliance may have responsibility for ensuring and monitoring that the guidelines set forth by the client are lawful and followed, and so on. In other words, there are many functional areas in the firm, all of which have to act or refrain from acting in order to make the client event successful.

The level of involvement or participation of different functional areas in the lifecycle of the event may vary, from being a decision maker, or a stake holder, to a mere receiver of the information related to the event. In some embodiments, functional areas may be required to approve, review or confirm a specific action that is being sought, whereas other functional areas may be required to sign-off, or still others that may be required to simply acknowledge the information. In some embodiments, the present invention provides a mechanism for enforcing and maintaining requisite levels of participations by integral functional areas, such that the lifecycle of the event at hand is successfully completed.

Although functional areas are quasi-static entities, some embodiments of the present invention provide means for adding and deleting functional areas, as well as for promoting or demoting their respective entitlements.

The term “case manager” is used interchangeably with “CLE® Officer” or “CLE® Manager” and defines an individual or a group of individuals responsible for managing and supervising the lifecycle of the event. In some embodiments, the case manager may also be tasked with maintaining the list of functional areas and managing their entitlements, while in other embodiments these tasks is the responsibility of the specially assigned administrator.

We now are referring back to FIG. 3. The case manager/CLE® Officer, upon receiving information about the proposed client event 310, enters the information pertinent to the event into the computer system and assigns integral functional areas according to the predetermined schedule that depends on the type of the event 320. For instance, in one exemplary embodiment the process of on-boarding of a new client may require Legal, Compliance and Investment Management functional areas to exercise their decision-making authorities, while in other embodiments, for example, terminating a client, may require Relationship Management, Investment Management, Legal, and Compliance to simply communicate their respective acknowledgements.

Going back to FIG. 3, once the event information is entered and the integral functional areas 340 are assigned, the functional areas relay to each other their approvals, rejections, concerns or other pertinent data 330 that is routed through the client lifecycle exchange management 350. While some functional areas may grant their respective approvals 360, other areas may withhold their approvals 385 as they deem appropriate.

In some exemplary embodiments, certain functional areas may be granted authorities to override decisions of the subordinate functional areas 390. For example, senior management may override decisions made by their subordinates, or, for example, Compliance may override approvals or rejections given by Database Manager, and so on.

In some exemplary embodiments, the present invention offers a mechanism for tracking the status of participation of each assigned integral functional area. For example, if the functional area delays its undertaking of the event, the,client lifecycle exchange management system may either remind the functional area about the delay, or escalate to the area's manager, or both. The aforementioned tracking status is referred to as the Alerts Function, the severity, periodicity and frequency of which can be set by the CLE® Manager depending upon the company's own policies and procedures for best practices or as prescribed by the company's risk management officer (RMO).

As also noted in FIG. 3, once all integral functional areas have fulfilled their tasks with regard to the event, including the CLE® Manager acting as the “approver of approvals” (i.e. the last approver), the lifecycle exchange management system then marks the event as complete, 370.

In some exemplary embodiments, the record of the completed event and the attached documentation are stored electronically, while in other embodiments a paper copy of the record and the documentation may also be sent to the case-specific permanent document storage area 395, with the outcome dependent on the company's policies and procedures with respect to documentation storage.

We now are reviewing exemplary embodiment of the graphical user interfaces (GUI) used by the CLE® Manager for entering information about the client event into the system. As we already explained, the CLE® Officer/CLE® or Case Manager, upon being notified about the event, selects functional areas integral to the event (FIG. 2 and FIG. 3) and initiates the event's lifecycle depending on the type of the event.

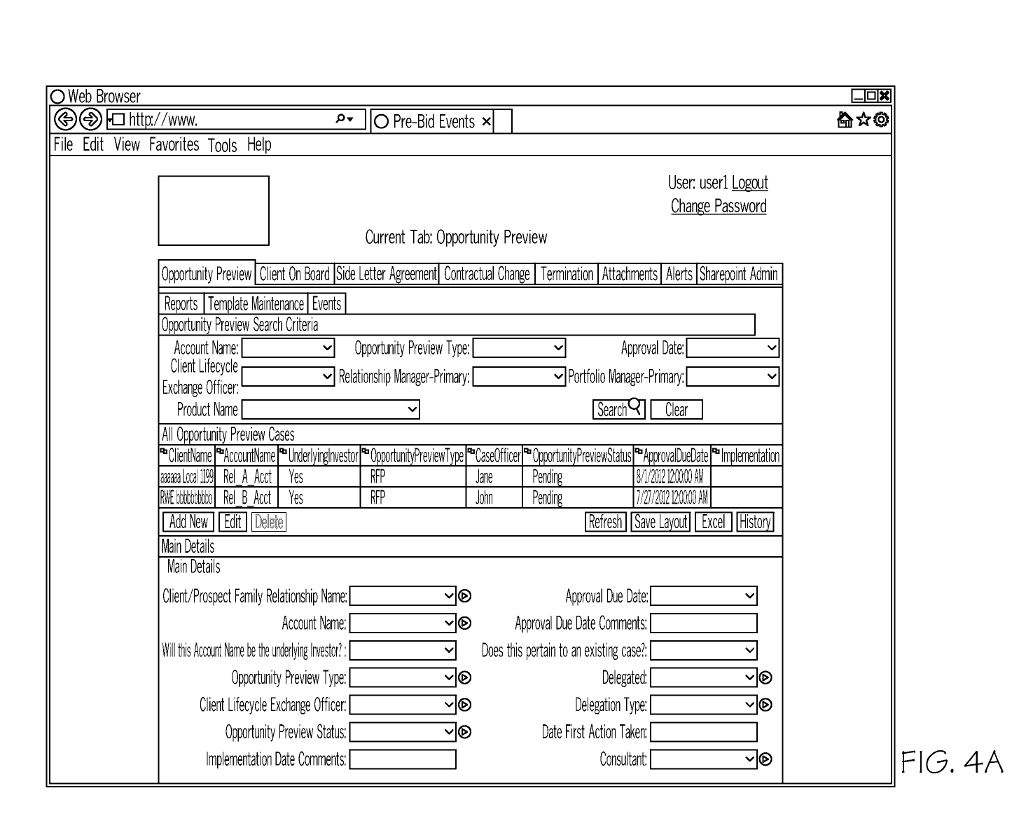

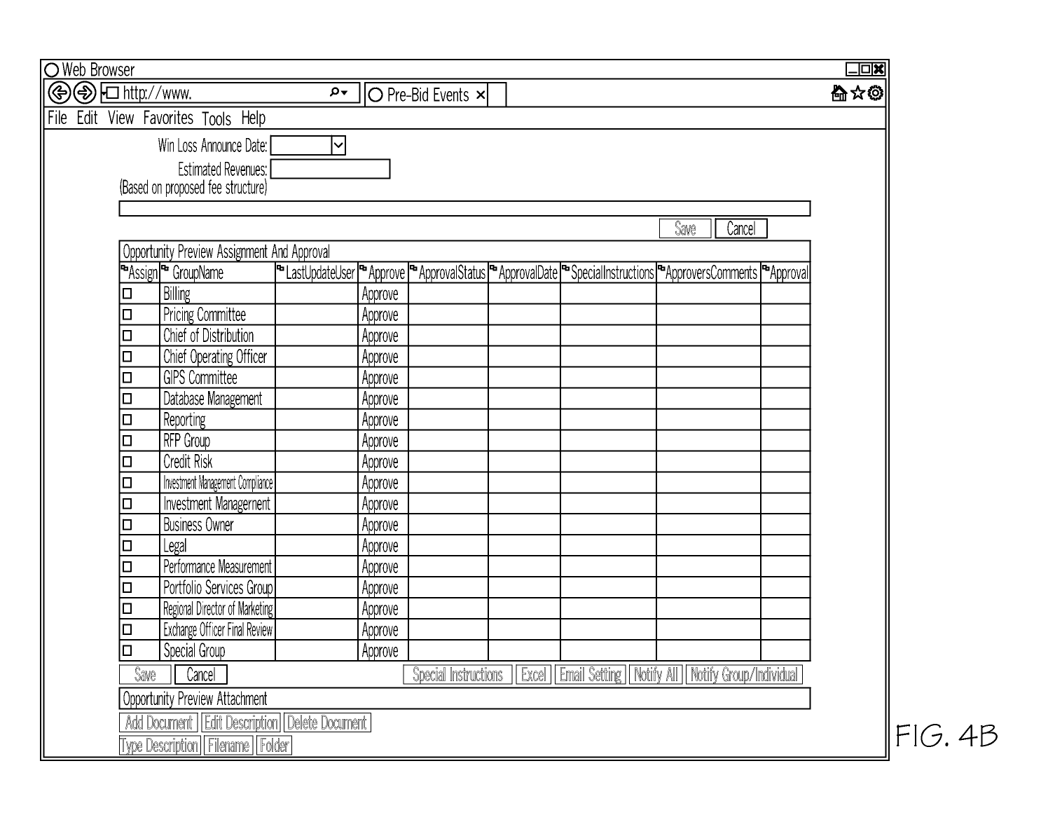

Turning now to FIG. 4A, we can see an exemplary embodiment of GUI illustrating CLE® Manager entering information about onboarding of a Prospective Client, and then to FIG. 4B, showing an exemplary embodiment of GUI used by CLE® Manager to select the integral functional areas to be assigned to the case at hand.

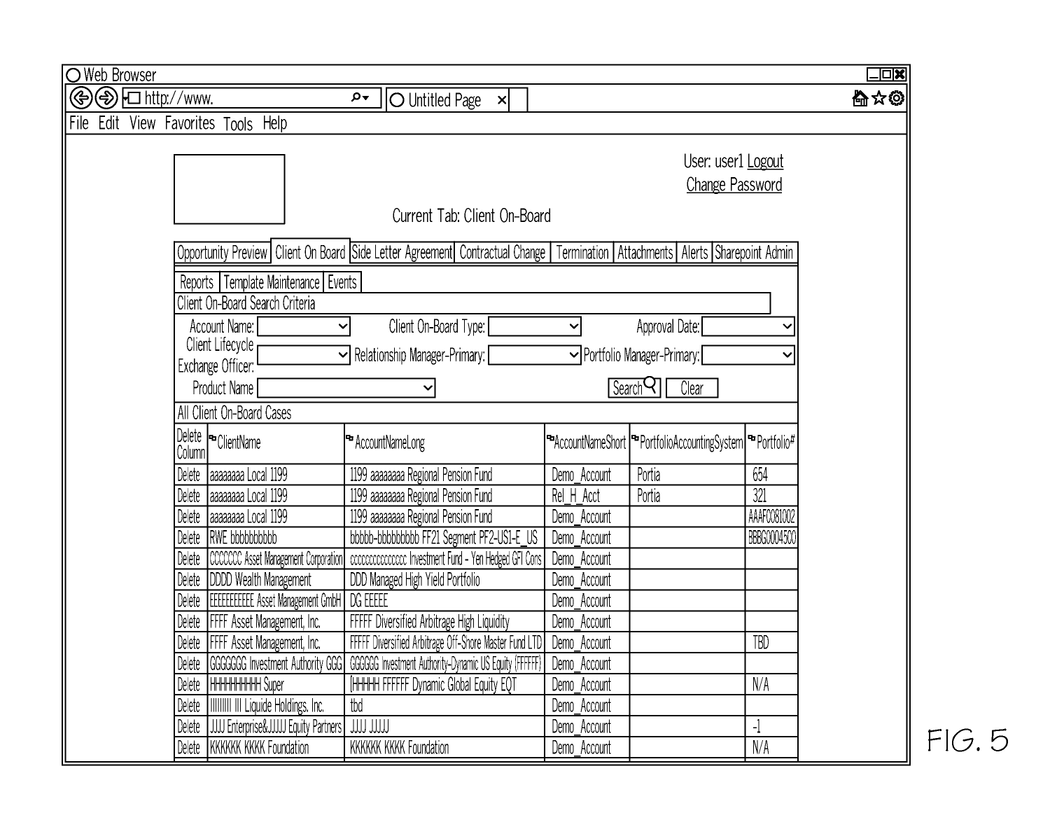

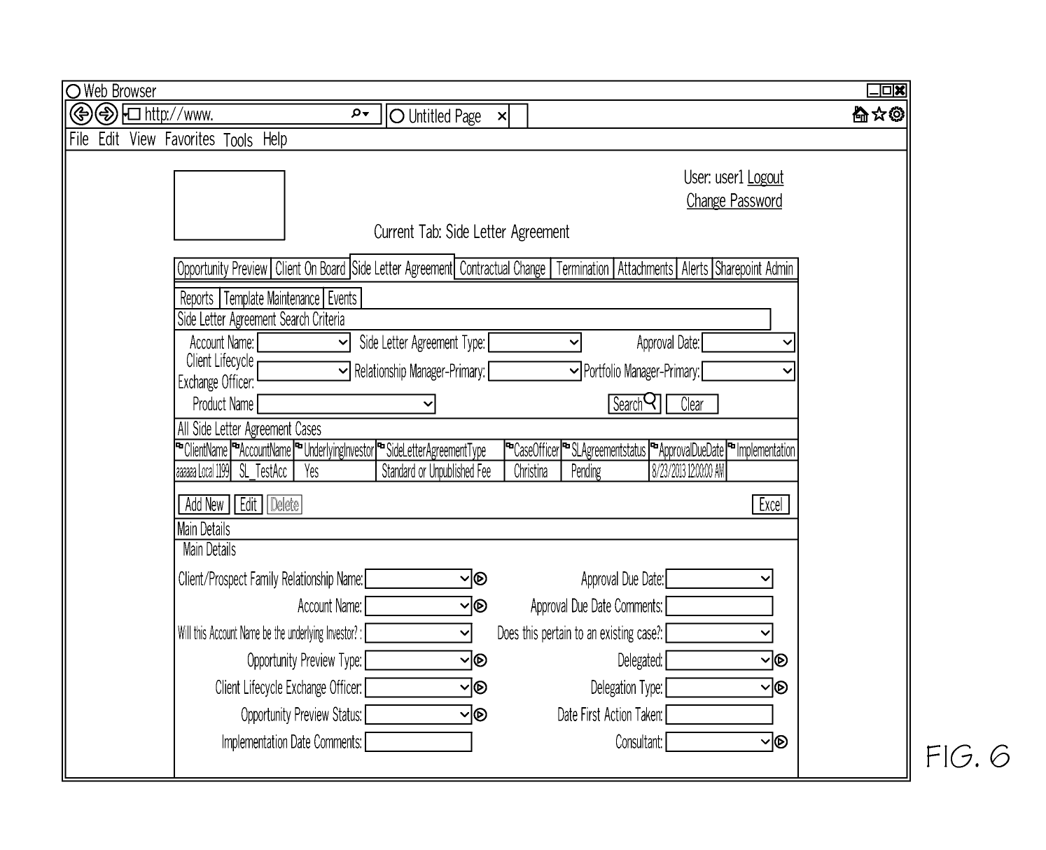

Furthermore, FIG. 5 shows an exemplary embodiment of GUI that enables CLE® Manager to enter information pertinent to the “New Client” event into the computer system, and then FIG. 6 that illustrates how CLE® Manager enters into the system the “Side Letter Agreement” event.

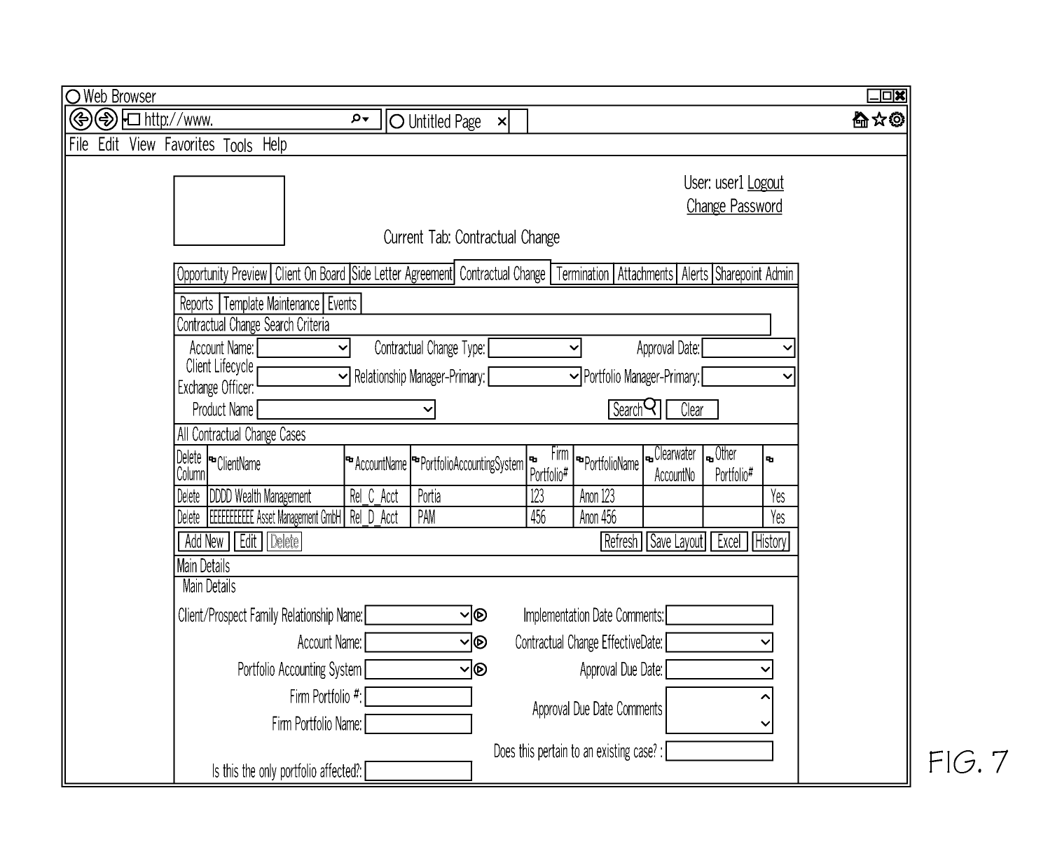

If the event at hand is concerned with changing existing contractual stipulation, FIG. 7 presents an exemplary embodiment of the “Contractual Changes” GUI.

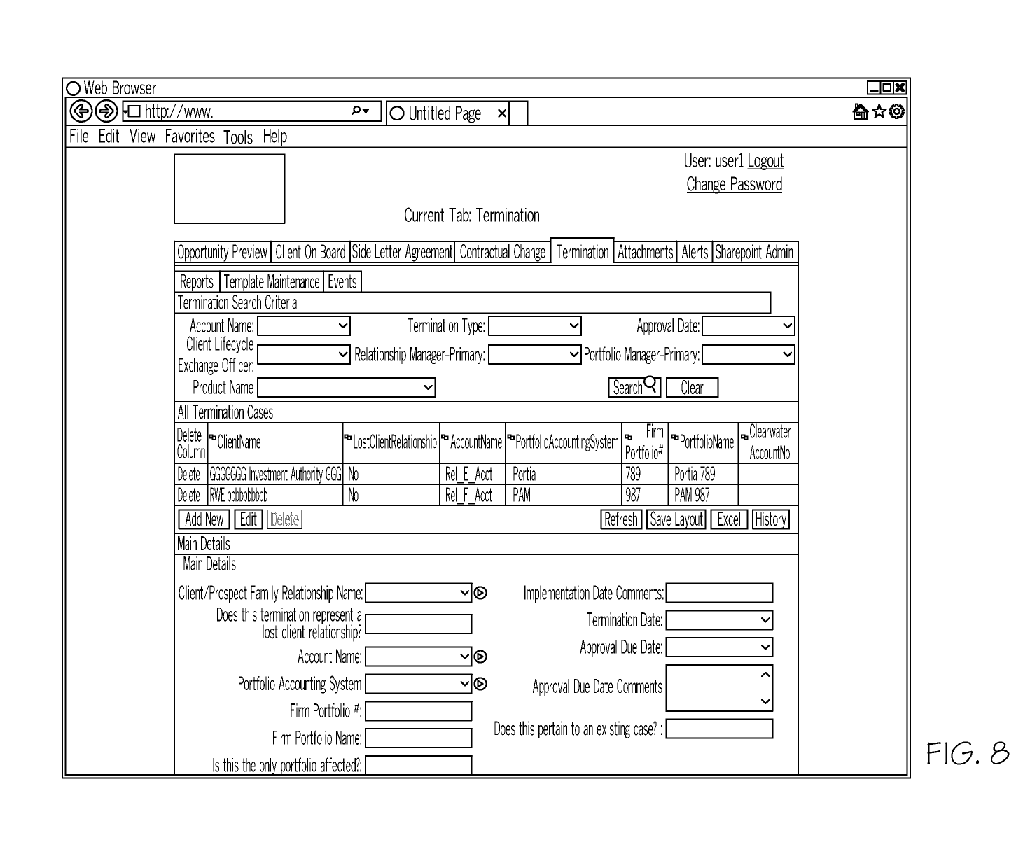

At the end of the client lifecycle continuum, CLE® Manager utilizes GUI shown in FIG. 8 to terminate the client's participation with the firm.

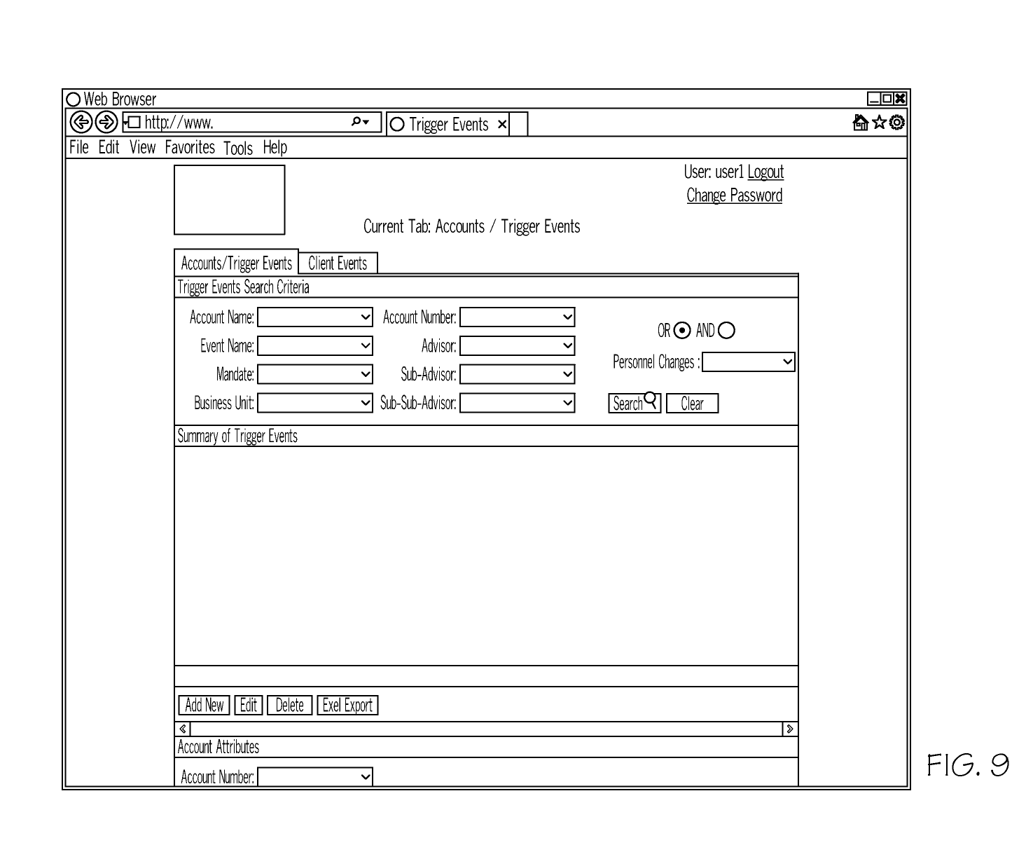

To execute tasks pertinent to outlining potential future deliverables (“Future Trigger Event”), CLE® Manager utilizes GUI shown in FIG. 9.

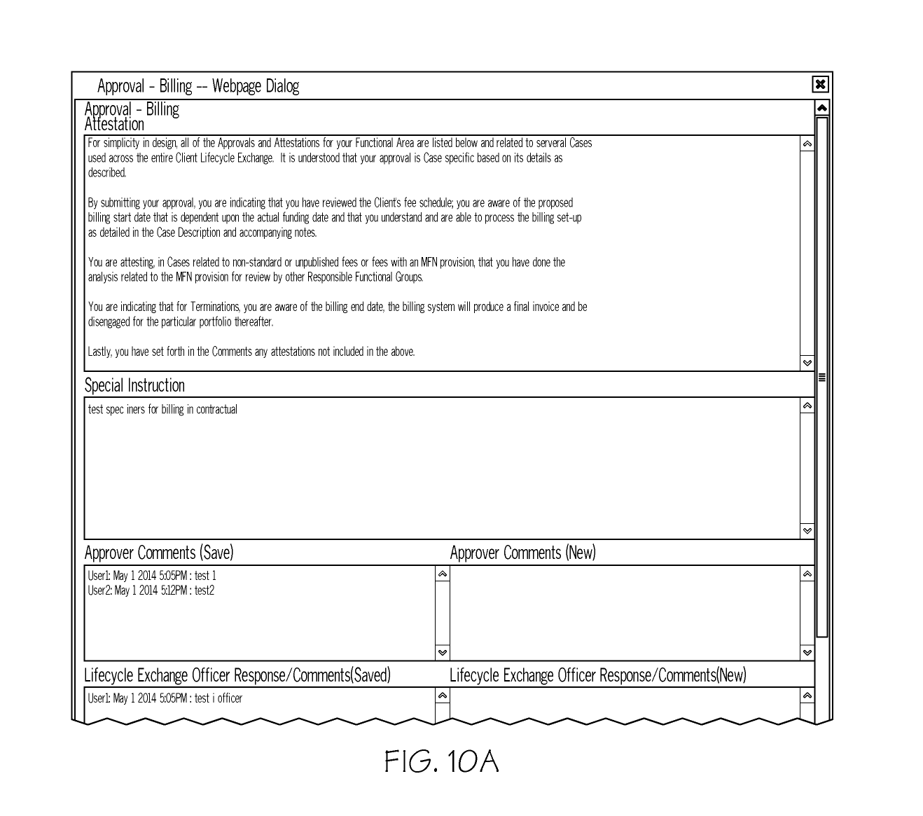

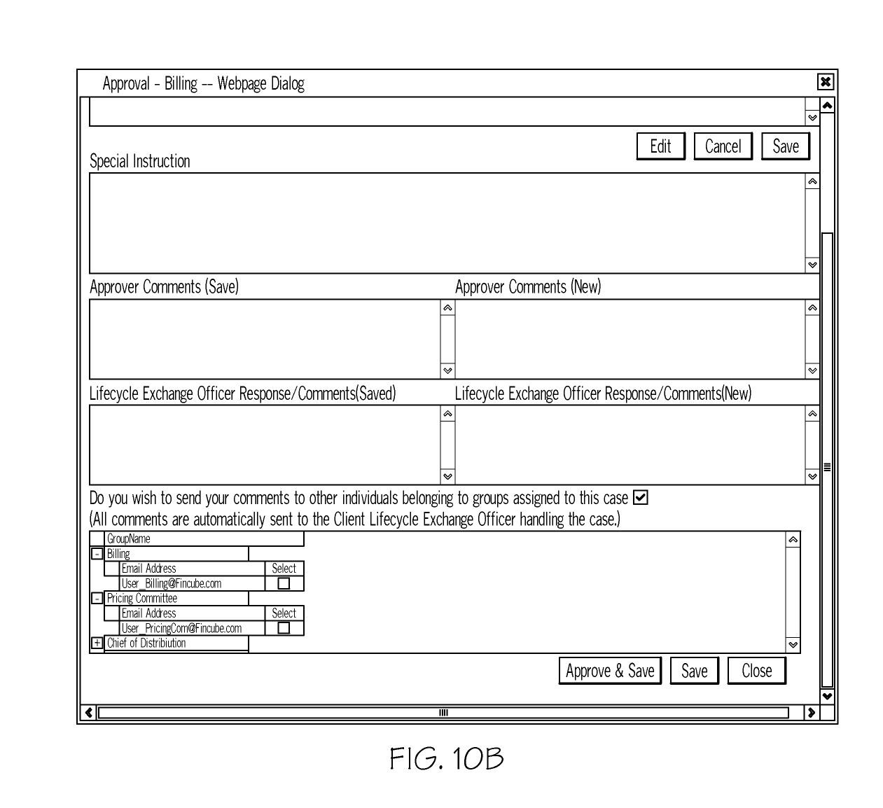

The present invention offers to the integral functional areas ability to communicate with each other via a so-called “Approver Attestation” dialog area where the integral functional areas can enter and save information relevant to the event at hand in a free format, such as special instructions, comments and attestations, among others. Please see FIG. 10A and 10B depicting such “Approver Attestation” dialog area.

In some exemplary embodiments, and upon receiving the notification of the event entered by CLE® Manager, the integral functional areas commence executing their tasks related to the event, including, but not limited to, date- and time-stamped approvals, rejections, acknowledgments or expression of concerns. In some embodiments, the information entered by the functional areas becomes viewable to other functional areas in real time; subject to the hierarchical set of security strata with read/write access granted as defined by the RMO or similarly positioned company officer concerned with risk management, as it gets routed through the system. In other embodiments, when the functional area is satisfied with the status of the event and acknowledges the completion of its tasks, the system sends electronic notifications to other integral functional areas.

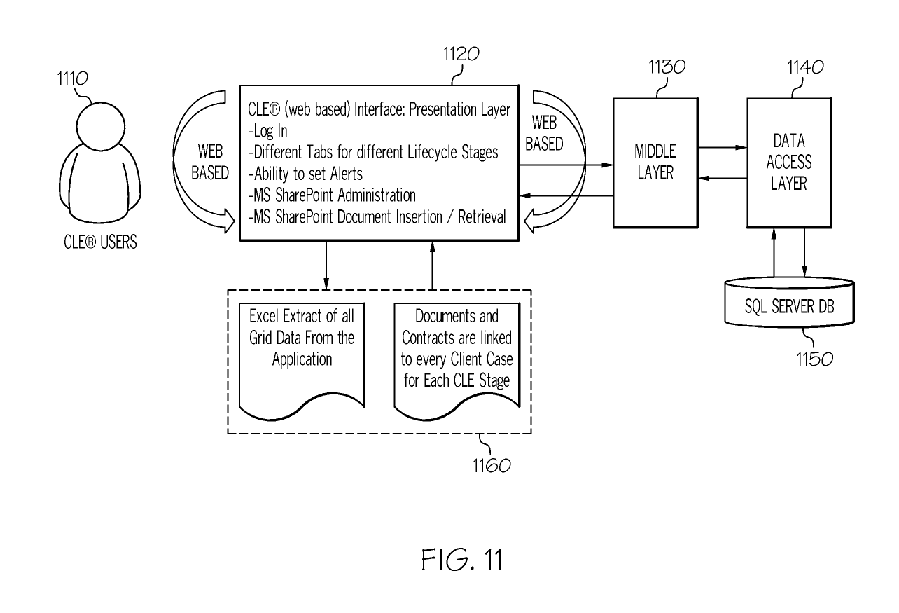

We now are turning our attention to FIG. 11 that depicts an exemplary embodiment of CLE® schematics. Web-based presentation layer 1120 is shown; however, N-tier or Intranet-based implementations of the presentation layer are expected. In some exemplary embodiments, the presentation layer comprises authenticated means for restricting access to the system to the authorized personnel only, means for entering and managing clients and events, means for selecting event lifecycle stages, means for managing alerts, means for document management, administration and retrieval, among others. In some exemplary embodiments, the content document management is implemented on MS SharePoint platform. The presentation layer may reside remotely or on the same device as the business logic or data modules described below. It may be based on a computer or terminal capable of digital communication and may communicate with the described below business and data modules using any type of electromagnetic communications via any type of electromagnetic channel or network.

Referring back to FIG. 11, middle layer 1130 serves as a business logic module that includes at least one computer-readable memory. In some embodiments, it contains controller cases. The middle layer may include a memory device, a processor, and software or other digital instructions. The middle layer may be embedded into the presentation layer or reside on a remote device, such as a server, memory or the like. The middle layer may communicate with the presentation module using any type of electromagnetic communications via any electromagnetic channel or network. The middle layer may include application programs, which utilize and/or manipulate the data in the data access module described below.

Referring again to FIG. 11, data access module 1140 controls database connectivity, data inputs and outputs, data modification and archiving, as well as load balancing, and other data-centric tasks. The data access module may contain application programs designed to manage database transactions as well as computer instructions or software code that converts the database transactions into sets of corresponding permitted operations for communication with the database module described below.

Continuing with FIG. 11, database module 1150 serves as data repository and may be based on any currently available or developed in the future relational, columnar or non-SQL database management system. The data repository stores and processes all information pertaining to the client event management. The data repository may be designed and implemented according to a variety of schemas; e.g., ontological model, existing relational or object-oriented framework, among others. The CLE® Officer or case manager or others authorized individual or entities may populate the database manually according to a predetermined plan or download the appropriate data from an authorized internal source of client reference data such as a populated client relationship management (CRM) system already employed by the company. The invention allows for capturing of any client data that is not already in possession by the company; thus, mitigating the risk associated with incomplete client data. Once populated, and regardless of source, data in the CLE® database may be modified, deleted, archived or otherwise manipulated.

Document management module 1160 enables grid data extracting, uploading, downloading, deleting and linking all the documents related to the client event at hand.

The foregoing modules of FIG. 11 are interconnected by the electromagnetic communication layer in form of any electromagnetic channels, including, but not limited to wired or wireless networks.

The foregoing workflow, exercised through a computer network-based system, offers a reliable mechanism for ensuring that the client event at hand is sufficiently traced and all pertinent documentation about the event is properly preserved.

Method embodiments described herein are computer-implemented. Some embodiments include computer-readable media encoded with a computer program (e.g. software), which includes instruction operable to cause an electronic device such as a computer or computer network to perform methods of various embodiments. A software implementation (or computer-implemented method) may include microcode, assembly language code, or a higher-level language code, which further may include computer readable instructions for performing various methods. The code may form portions of computer program products. Further, the code may be tangibly stored on one or more volatile or non-volatile computer-readable media during execution or at other times. These computer-readable media may include, but not limited to, hard disks, removable magnetic disks, removable optical disks (e.g. computer disks and digital video disks), memory cards or sticks, random access memories (RAM), read only memories (ROM), and the like.

It should be appreciated from the forgoing that the invention described herein offers a method, a system, and a computer-implemented algorithm for managing and coordinating various client-related events. The resulting solution improves the overall process of on-boarding new clients and products, making changes to the existing clients and products, and managing the lifecycle of any project involving more than one department in the firm.

The description of the present embodiment has been presented for purposes of illustration, but is not intended to be exhaustive or to limit the invention to the form disclosed. Many modifications and variations will be apparent to those of ordinary skill in the art. For example, the processes of the present invention are capable of being distributed in the form of a computer readable medium of instructions. Such computer readable medium may have a variety of forms. The present invention applies equally regardless of the particular type of signal bearing media actually used to carry out the distribution. Examples of tangible computer readable media include recordable-type media such a flush drive, a hard disk drive, a RAM, and CD-ROMs. Examples of transmission-type media include digital and analog communications links.

Various embodiments implement the one or more software programs in various ways, including procedure-based techniques, component-based techniques, and/or object-oriented techniques, among others. Specific examples include C#, .NET and commercial class libraries. Those of ordinary skill in the art will appreciate that the hardware depicted herein may vary depending on the implementation. The depicted example is not meant to imply architectural limitations with respect to the present invention.

The terms “logic,” “model” and “memory” may have been used herein. While the logic and model referred to herein have generally be described in terms of instructions, data structures and computer processes, it should be understood that these terms may alternatively refer to circuitry that is part of the design for an integrated circuit chip.

Herein above, or in the following claims, the term “comprises” is synonymous with “includes.” The use of terminology such as “X comprises A, B and C” is not intended to imply that A, B and C are necessarily the only components or most important components of X.

Unless clearly and explicitly stated, the claims that follow are not intended to imply any particular sequence of actions. The inclusion of labels, such as a), b), c) or 1), 2), 3) etc., for portions of the claims does not, by itself, imply any particular sequence, but rather is merely to facilitate reference to the portions.

To reiterate, the embodiments were chosen and described in order to best explain the principles of the invention, the practical application, and to enable others of ordinary skill in the art to understand the invention. Various other embodiments having various modifications may be suited to a particular use contemplated, but may be within the scope of the present invention.

We claim:

1. A client lifecycle exchange management method comprising:
receiving, by a process running on a computer system, information related to a client event;
correlating and transmitting electronically said information to a plurality of integral functional areas, said integral functional areas selected from the group comprising organizational entities, departments, individuals and groups of individuals;
allowing real time collaboration between said integral functional areas as to said client event;
monitoring workflow application processes running on said computer system, wherein the workflow applications enable real time collaboration between said functional areas and reporting about tasks, wherein the monitoring includes monitoring compliance with special instruction, comments and attestations entered by said integral functional areas;
alerting functional areas across the firm as to delays in the management of said client lifecycle event;
triggering deliverables from said integral functional areas into whose responsibility was to have been assigned said client lifecycle event;
uploading, downloading, exchanging and storing electronically documentation pertinent to said client event; and
storing electronic records of said client event in a database management system.

2. The client lifecycle exchange management method according to claim 1, wherein said client event comprising Opportunity Preview, Client On-Board, Side-Letter Agreements, Contractual Changes, Termination, Trigger Events, New Product Development, Vendor Contract Analysis, and Customized Workflow.

3. The client lifecycle exchange management method according to claim 1, wherein said plurality of integral functional areas comprising Relationship Management, Sales, Investment Management, Portfolio Management, Database Management, Consultant Database Management, Pricing and Product Management, Billing and Fees, Legal, Compliance, Accounting, Reporting, Operations, Performance, GIPS® Committee, Insurance, and Tax.

4. A computer-implemented algorithm for client lifecycle exchange management system, said computer-implemented algorithm comprising:
a computer readable storage medium having computer readable program code embodied therewith, said computer readable program code further comprising:
computer readable program code configured to cause a computer system to receive information related to a client event;
computer readable program code configured to cause correlating and transmitting electronically said information to a plurality of integral functional areas;
computer readable program code configured to allow real time collaboration between said integral functional areas as to said client event;
computer readable program code configured to cause monitoring workflow application processes, wherein said monitoring includes monitoring compliance with special instruction, comments and attestations entered by said integral functional areas;
computer readable program code configured to support uploading, downloading, exchanging and storing electronically documentation pertinent to said client event; and
computer readable program code configured to support storing an electronic record of said event in a database management system.

5. The computer-implemented algorithm for said client lifecycle exchange management system according to claim 4, wherein said client event comprising Opportunity Preview, Client On-Board, Side-Letter Agreements, Contractual Changes, Termination, Trigger Events, New Product Development, Vendor Contract Analysis, and Customized Workflow.

6. The computer-implemented algorithm for said client lifecycle exchange management system according to claim 4, wherein said plurality of integral functional areas comprising Relationship Management, Sales, Investment Management, Portfolio Management, Database Management, Consultant Database Management, Pricing and Product Management, Billing and Fees, Legal, Compliance, Accounting, Reporting, Operations, Performance, GIPS® Committee, Insurance, and Tax.

7. A client lifecycle exchange management computer system comprising:
a processor; and
a storage device connected to said processor, wherein said storage device has stored thereon a client lifecycle exchange management software program for controlling said processor, and wherein said processor is operative with said program to execute said program for receiving information related to a client event;
wherein said processor is operative with said program to execute said program for automatically correlating and transmitting electronically said information to a plurality of integral functional areas;
wherein said processor is operative with said program to execute said program for allowing real time collaboration between said integral functional areas as to said client event;
wherein said processor is operative with said program to execute said program for monitoring workflow application processes, wherein said monitoring includes monitoring compliance with special instruction, comments and attestations entered by said integral functional areas;
wherein said processor is operative with said program to execute said program for uploading, downloading, exchanging and storing electronically documentation pertinent to said client event; and
wherein said processor is operative with said program to execute said program for storing an electronics record of said event in a database management system.

8. The client lifecycle exchange management computer system according to claim 7, said client event comprising Opportunity Preview, Client On-Board, Side-Letter Agreements, Contractual Changes, Termination, Trigger Events, New Product Development, Vendor Contract Analysis, and Customized Workflow.

9. The client lifecycle exchange management computer system according to claim 7, wherein said plurality of integral functional areas comprising Relationship Management, Sales, Investment Management, Portfolio Management, Database Management, Consultant Database Management, Pricing and Product Management, Billing and Fees, Legal, Compliance, Accounting, Reporting, Operations, Performance, GIPS® Committee, Insurance, and Tax.
